(19) United States
(12) Patent Application Publication
(10) Pub. No.: US 2002/0015241 A1
(43) Pub. Date: Feb. 7, 2002

(54) Dual rear vision mirror

(76) Inventor: Arthur J. Belaire, Newport, NH (US)

Correspondence Address: Law Offices of John D. Gugliotta, P.E., Esq., 202 Delaware Building, 137 South Main Street, Akron, OH, 44308, US

(21) Appl. No.: 09/963,910

(22) Filed: Sep. 26, 2001

Related U.S. Application Data
(63) Continuation of application No. 09/547,947, filed on Apr. 12, 2000.

(51) Int. Cl. G02B 5/08; G02B 7/182

(52) U.S. Cl. 359/866; 359/840; 359/850

(57) ABSTRACT

A multi-view side view mirror is provided having a mechanism that utilizes two individual mirrors, an upper mirror and an lower mirror. Along the side of the care, the mirrors are placed in the same position as conventional side-view mirrors. Although housed in the same frame, the lower mirror is independently functional of the other.

Street and highway safety is at the forefront of concerns when speaking in regards to public safety. With the ever increasing volume of cars on the road, deaths and injuries resulting from traffic accidents continue to be an all too common occurrence. While the true “accident”, i.e. those that really do happen as a matter of chance or a momentary lapse of driver attention can never be prevented, those that occur as a result of less than optimum driving conditions can. Many accidents occur due to vehicles and objects being in the “blind spot” of a driver, or the area along side a motor vehicle that cannot be seen by either direct observation by the driver or by the use of rear view or side view mirrors. There have been attempts made to reduce this problem by the use of parabolic mirrors, but they often distort the field of view and may cause even more accidents.

A search was conducted of the existing art in an attempt to find a solution to this problem, and although the following references were discovered, none read directly on the claims of the present invention. The following patents disclose the design and function of an auxiliary rearview mirror assembly for attachment to a vehicle's rearview mirror:

U.S. Pat. No. 5,784,211 issued in the name of Mingledorff

U.S. Pat. No. 4,927,255 issued in the name of Martinez

U.S. Pat. No. 4,381,142 issued in the name of McColgan

U.S. Pat. No. D 274,054 issued in the name of Barows

The following patents describe the design and function of a rearview mirror apparatus for automobiles that eliminates blind spots:

U.S. Pat. No. 4,575,202 issued in the name of McGuire

U.S. Pat. No. D 409,127 issued in the name of Kim et al.

U.S. Pat. No. D 403,287 issued in the name of Kim et al.

U.S. Pat. No. D 403,286 issued in the name of Kim et al.

U.S. Pat. No. D 318,644 issued in the name of Rodrigues et al.

Consequently, a need has therefore been felt for an improved but less complex mechanism to enable a driver to see various points along the side of a vehicle.

### SUMMARY OF THE INVENTION

Therefore, it is an object of the invention to provide an automobile side view mirror.

It is a feature of the present invention to provide an automobile side view mirror having dual mirror sections wherein an upper section is configured to rotate horizontally relative to the lower section and both sections are mounted on support that is free to rotate horizontally.

Briefly described according to one embodiment of the invention, a dual rear vision mirror is provided as a rear view mirror on a motor vehicle with enhanced features to eliminate the dangers associated with blind spots. The invention strongly resembles a conventional mirror in that it has a mirrored surface enclosed within a plastic frame that is capable of being adjusted by the driver to suit his or her physical requirements. The lower portion of the mirror, which is the largest in size, is adjusted so the driver can see behind him in a conventional manner. The upper portion of the mirror is slanted back a few degrees in a fixed manner so the driver can see more of the area around his or her vehicle. In an alternate embodiment of the invention, the upper portion is adjustable with respect to the lower portion, so the driver may fine tune the area that is seen. Whatever embodiment is used, when the mirror is properly positioned as aforementioned described, the driver can see the normal area around the car in the lower mirror, and the blind spot area in the upper mirror.

An advantage of the present invention is it allows for increased safety for all motorists by eliminating or reducing blind spots around a motor vehicle while driving.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front elevational view of a dual rear vision view mirror to the preferred embodiment of the present invention;

FIG. 2 is a top plan view thereof;

FIG. 3 is a side elevational view thereof; and

FIG. 4 is a perspective view thereof.

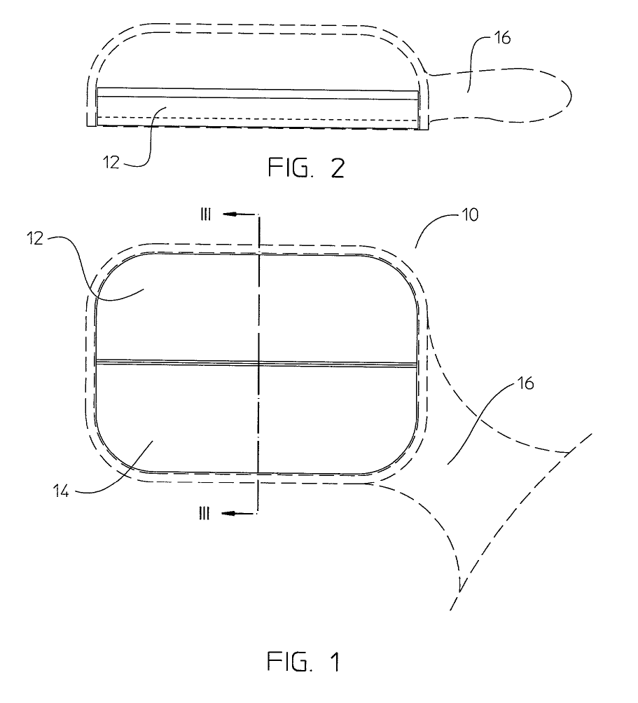

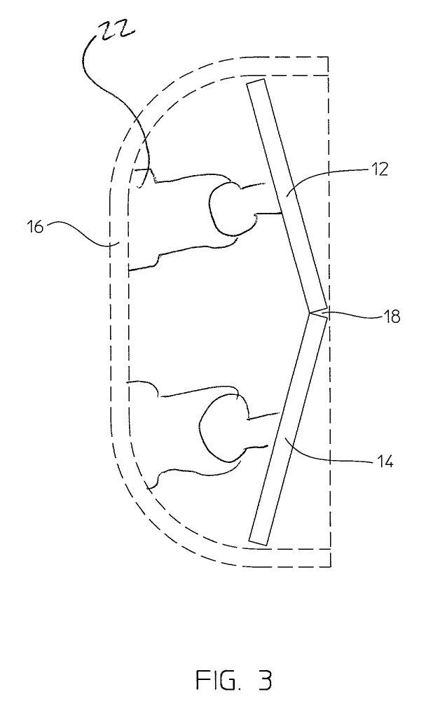

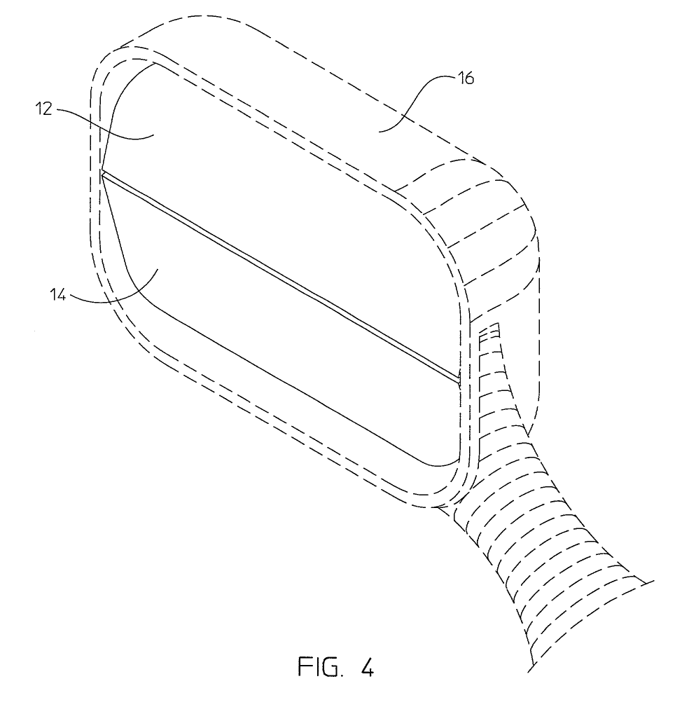

### DESCRIPTION OF THE PREFERRED EMBODIMENTS

Referring now to the Figures, a multi-view side view mirror 10 is provided having a mechanism that utilizes two individual mirrors, an upper mirror 12 and an lower mirror 14. Housed in the same frame 16, each mirror is independently functional of the other. According to the preferred embodiment, the upper portion 12 of the mirror is attached rigidly within the frame 16. It is envisioned that the frame 16 is pivotally adjustable in relation to the vehicle as is otherwise conventionally commercially available. The lower mirror 14 is independently, pivotally adjustable in relation to the upper mirror 12. In this manner the user has dual adjustablility for varying the sight area around his or her vehicle.

It is envisioned that the lower mirror 14 is affixed to the frame 16 by use of a pivotal connection means 18.

According to an alternate embodiment, an electronic control unit 22 provides control for the user, and is in electrical communication with a plurality of drive motors. Each drive motor in physical communications with a mirror 12, 14, such that the drive motor is capable of positioning the respective mirror along either a lateral or vertical plane.

It is envisioned that conventionally available mirror drive motors of the type in current usage would suffice, both other types of motors, both conventional and innovative, may be adapted to such use. The control unit 18 thereby allows for the independent positioning of the lower mirror 14, and upper mirror 12, and is further capable of controlling a plurality, herein envisioned as two separate such mirror assemblies.

Along the side of the car, the mirrors are placed in the same position as conventional side-view mirrors. By positioning the mirrors via the electronic control unit 22, the mirrors can be independently controlled and positioned to eliminate the driver's “blind spot”.

Uses and embodiments of the present teachings are vast. The foregoing description is included to illustrate the operation of the preferred embodiment and is not meant to limit the scope of the invention. The scope of the invention is to be limited only by the following claims.

What is claimed is:

1. A multi-view side view mirror unit comprising:
an upper mirror;
an lower mirror;
a mirror housing frame for housing both said upper mirror and said lower mirror;
pivotal connection means affixing said lower mirror to said mirror housing frame,
wherein said lower mirror is independently, pivotally adjustable in relation to the upper mirror.

2. The multi-view side view mirror unit of claim 1, further comprising a mirror control means for controlling the planar positioning of said pivotal control means.

3 The multi-view side view mirror of claim 2, wherein said mirror control means comprises:
a drive motor in physical communication with said mirror; and
an electronic control unit in electrical communication with said drive motors;
and wherein said control unit thereby allows for the independent positioning of said lower mirror and said upper mirror.
